(19) United States
(12) Patent Application Publication
(10) Pub. No.: US 2025/0289554 A1
(43) Pub. Date: Sep. 18, 2025

(54) INFORMATION PROCESSING METHOD AND PROGRAM

(71) Applicant: TOYOTA JIDOSHA KABUSHIKI KAISHA, Toyota-shi (JP)

(72) Inventors: Kosuke AKATSUKA, Mishima-shi (JP); Shuichi TAMAGAWA, Kitanagoya-shi (JP)

(73) Assignee: TOYOTA JIDOSHA KABUSHIKI KAISHA, Toyota-shi (JP)

(21) Appl. No.: 19/041,387

(22) Filed: Jan. 30, 2025

(30) Foreign Application Priority Data
Mar. 18, 2024 (JP) 2024-042617

(51) Int. Cl. B63H 21/21; G05D 1/223; G05D 109/30

(52) U.S. Cl. CPC B63H 21/21; G05D 1/2232; B63H 2021/216; G05D 2109/34

(57) ABSTRACT

In an information processing method for remotely controlling a marine vessel using a mobile terminal, the mobile terminal detects that the mobile terminal is tilted from a neutral posture. Then, in response to detecting that the mobile terminal is tilted from the neutral posture, the mobile terminal transmits, to the marine vessel, a command for generating a propulsive force corresponding to at least one of a plurality of propulsion directions including a propulsion direction for translating the marine vessel in the front-rear direction, a propulsion direction for translating the marine vessel in the left-right direction, and a propulsion direction for turning the marine vessel in the left-right direction.

### CROSS-REFERENCE TO RELATED APPLICATION

This application claims priority to Japanese Patent Application No. 2024-042617 filed on Mar. 18, 2024, incorporated herein by reference in its entirety.

### BACKGROUND

### 1. Technical Field

The present disclosure relates to an information processing method and a program.

### 2. Description of Related Art

There is known a technology in which the course, thrust, etc. of a marine vessel are set on an operation screen displayed on a tablet terminal (see, for example, Japanese Unexamined Patent Application Publication No. 2020-132095 (JP 2020-132095 A)).

### SUMMARY

An object of the present disclosure is to provide a technology capable of improving operability when a marine vessel is remotely operated.

One aspect of the present disclosure is an information processing method for remotely operating a marine vessel using a mobile terminal. In this case, the information processing method may include, for example,
causing the mobile terminal to perform:
detecting a tilt of the mobile terminal from a neutral posture; and
transmitting, to the marine vessel, a command for generating a propulsive force corresponding to at least a first propulsion direction out of a plurality of propulsion directions in response to the detecting of the tilt of the mobile terminal from the neutral posture.

Another aspect of the present disclosure may be an information processing program for causing a computer to perform the above information processing method, or a non-transitory storage medium storing the information processing program.

According to the present disclosure, it is possible to provide the technology capable of improving the operability when the marine vessel is remotely operated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an example of a configuration of a remote maneuvering system according to an embodiment;

FIG. 2 is a diagram schematically illustrating an example of a configuration of each of a marine vessel and a mobile terminal according to the embodiment;

FIG. 3 is a diagram for describing an example of a procedure of remote operation in the embodiment;

FIG. 4 is a diagram for describing an example of a method of determining a magnitude of a propulsive force in the embodiment;

FIG. 5 is a flow chart illustrating an exemplary process routine executed by the mobile terminal according to the embodiment; and

FIG. 6 is a diagram for explaining an example of a procedure of remote operation in a modified example.

### DETAILED DESCRIPTION OF EMBODIMENTS

Technologies for remotely controlling a marine vessel using a mobile terminal such as a smartphone or a tablet terminal have been developed. As an example, a technique is known in which an operation screen including a plurality of display fields indicating the status of a marine vessel, a plurality of buttons for selecting the magnitude of the propulsive force of the marine vessel, and a plurality of buttons for selecting the course of the marine vessel and a variety of GUI components are displayed on a mobile terminal, and the magnitude of the propulsive force and the course selected by the user on the operation screen are transmitted from the mobile terminal to the marine vessel by radio communication. According to such a technique, the user can maneuver the marine vessel while visually observing the situation around the marine vessel at a place away from the cockpit (for example, a deck or the like). However, in the above-described example, it is difficult for the user to intuitively operate the vessel, and there is room for improvement in operability.

One aspect of the present disclosure is an information processing method for remotely operating a marine vessel using a mobile terminal. In the information processing method according to the present disclosure, the mobile terminal detects that the mobile terminal is tilted from the neutral posture. In an example, the neutral posture may be a posture of the mobile terminal at a time point when remote control of the marine vessel is started. The time point at which the remote operation of the marine vessel is started may be arbitrarily designated by the user. The inclination of the mobile terminal from the neutral posture may be at least one of an inclination about an axis in the left-right direction of the mobile terminal, an inclination about an axis in the up-down direction of the mobile terminal, and an inclination about an axis in the front-rear direction of the mobile terminal in an example.

In the information processing method according to the present disclosure, in response to detecting that the mobile terminal is tilted from the neutral posture, the mobile terminal transmits a command to generate a propulsive force corresponding to at least the first propulsive direction among the plurality of propulsive directions to the marine vessel. The plurality of propulsion directions may include, in one example, at least one of a front-rear direction of the marine vessel (translating forward and translating backward), a left-right direction of the marine vessel (translating rightward and translating leftward), and a turning direction of the marine vessel (pivoting rightward and pivoting leftward). The first propulsion direction may be at least one of the plurality of propulsion directions described above.

According to the information processing method of the present disclosure, the user can propel the marine vessel in the first propulsion direction by tilting the mobile terminal from the neutral position. Accordingly, the user can intuitively remotely operate the marine vessel.

Further, the mobile terminal used in the information processing method according to the present disclosure may be, for example, a terminal including a touch panel display. In this case, in response to the mobile terminal detecting the touch operation of the touch panel display, the mobile terminal may further execute transmitting a command to generate a propulsive force corresponding to a second propulsive direction different from the first propulsive direction among the plurality of propulsive directions to the marine vessel. The touch operation according to the present disclosure may be, for example, a vertical slide touch operation on a touch panel display and/or a horizontal slide touch operation on a touch panel display. As a result, operability can be improved when the operation with respect to the first propulsion direction and the second propulsion direction is performed simultaneously.

Here, in a case where the remote operation of the marine vessel is performed by using the inclination of the mobile terminal and the touch operation of the touch panel display in combination, in an example, the first propulsion direction may be set to the turning direction of the marine vessel, and the second propulsion direction may be set to the front-rear direction and/or the left-right direction of the marine vessel. That is, in accordance with any one of the inclination of the mobile terminal about the axis in the left-right direction, the inclination of the mobile terminal about the axis in the up-down direction, and the inclination of the mobile terminal about the axis in the front-rear direction, the turning of the marine vessel may be performed, and the translational movement of the marine vessel in the front-rear direction and/or the translational movement of the marine vessel in the left-right direction may be performed in accordance with the vertical sliding touch operation on the touch panel display and/or the sliding touch operation in the left-right direction on the touch panel display.

Further, in the information processing method according to the present disclosure, the mobile terminal may further execute acquiring the amount of inclination of the mobile terminal from the neutral posture, determining the magnitude of the propulsive force in the first propulsion direction according to the acquired amount of inclination, and transmitting a command specifying the determined magnitude of the propulsive force to the marine vessel. Accordingly, the user can intuitively operate the propulsive force of the marine vessel in addition to the propulsive direction of the marine vessel.

Hereinafter, specific embodiments of the present disclosure will be described with reference to the drawings. The hardware configuration, the module configuration, the functional configuration, and the like described in the following embodiments are not intended to limit the technical scope of the disclosure only thereto unless otherwise specified.

### EMBODIMENTS

In the present embodiment, an example in which the present disclosure is applied to a remote maneuvering system will be described. The remote maneuvering system according to the present embodiment is a system that remotely operates a marine vessel by using a mobile terminal.

### Overview of Remote Maneuvering System

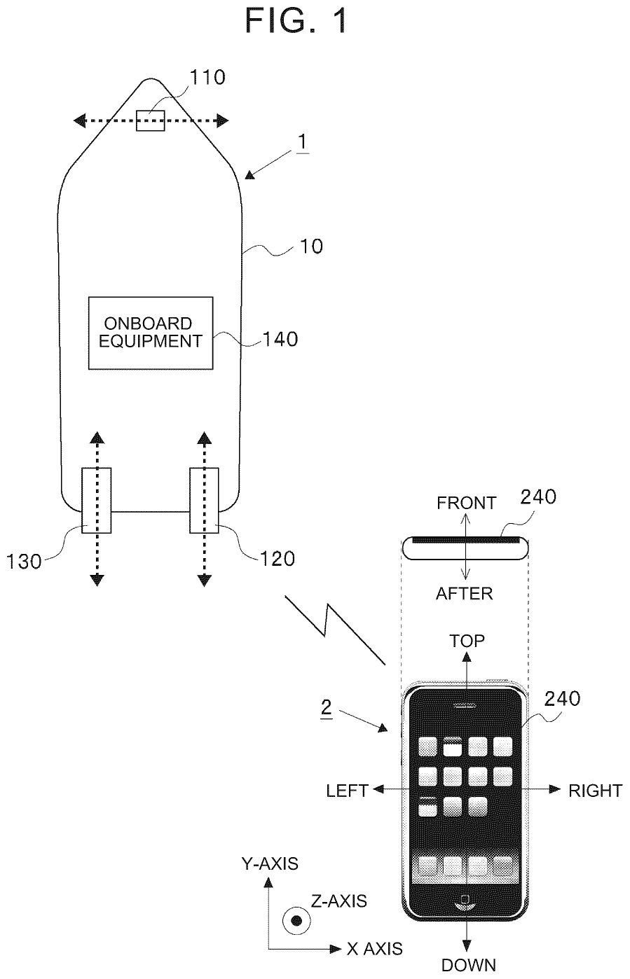

FIG. 1 is a diagram illustrating an outline of a remote marine vessel maneuvering system according to the present disclosure. As shown in FIG. 1, the remote maneuvering system according to the present disclosure includes a marine vessel 1 and a mobile terminal 2.

The marine vessel 1 includes a bow thruster 110 mounted on a bow portion of the hull 10, two engines 120 to 130 mounted on a stern portion of the hull 10, and an onboard device 140. The bow thruster 110 is a propulsion unit that generates a propulsive force for propelling the bow portion of the hull 10 in the left-right direction. The engines 120 to 130 are thrusters that generate a propulsive force that propels the stern portion of the 20 hull 10 in the front-rear direction. In the following description, of the two engines 120 to 130, the engine 120 installed on the right side of the hull 10 is referred to as a right engine 120, and the engine 130 installed on the left side of the hull 10 is referred to as a left engine 130. Further, in the description of the present embodiment, the bow thruster 110, the right engine 120, and the left engine 130 may be collectively referred to as an “engine”. The onboard device 140 is a computer that controls the engine in accordance with a remote signal transmitted from the mobile terminal 2. The remote signal is a signal including a command for specifying the propulsion direction of the marine vessel 1 and a command for specifying the magnitude of the propulsive force in the propulsion direction.

Note that the configuration of the marine vessel 1 is not limited to the example shown in FIG. 1, and the arrangement and the number of engines may be appropriately changed according to the embodiment as long as the configuration is capable of translating in the front-rear left-right direction and turning in the left-right direction.

The marine vessel 1 configured as described above is advanced (translated forward) by the right engine 120 and the left engine 130 generating a propulsive force for propelling the stern portion forward in a state where the bow thruster 110 is stopped. In a state where the bow thruster 110 is stopped, the right engine 120 and the left engine 130 generate a propulsive force for propelling the hull 10 backward, and thus, the marine vessel 1 retreats (translates backward). The marine vessel 1 translates leftward by the bow thruster 110 generating a propulsive force that propels the bow portion leftward and the right engine 120 and the left engine 130 generating a propulsive force that propels the stern portion rightward (the right engine 120 generating a propulsive force that propels the hull 10 rearward and the left engine 130 generating a propulsive force that propels the hull 10 forward). The marine vessel 1 translates to the right by generating a propulsive force that the bow portion of the bow thruster 110 propels to the right, and generating a propulsive force that the right engine 120 and the left engine 130 propel the stern portion to the left (the right engine 120 generates a propulsive force that propels the hull 10 forward, and the left engine 130 generates a propulsive force that propels the hull 10 backward). The marine vessel 1 turns leftward by the bow thruster 110 generating a propulsive force to propel the bow portion leftward and the right engine 120 and the left engine generating a propulsive force to propel the stern portion rightward (the right engine 120 generating a propulsive force to propel the hull 10 forward and the left engine 130 generating a propulsive force to propel the hull 10 backward). The marine vessel 1 turns in the rightward direction by the bow thruster 110 generating a propulsive force to propel the bow portion in the rightward direction and the right engine 120 and the left engine generating a propulsive force to propel the stern portion in the leftward direction (the right engine 120 generating a propulsive force to propel the hull 10 backward and the left engine 130 generating a propulsive force to propel the hull 10 forward).

The mobile terminal 2 is a portable computer used by a user who remotely operates the marine vessel 1, such as a smartphone or a tablet terminal. The mobile terminal 2 in the present embodiment is equipped with a touch panel display 240 as an input/output device. Hereinafter, the left-right direction of the mobile terminal 2 when the surface on which the touch panel display 240 is provided is viewed in front is referred to as an X-axis, the up-down direction is referred to as a Y-axis, and the front-rear direction (the direction perpendicular to the surface on which the touch panel display 240 is provided) is referred to as a Z-axis.

The mobile terminal 2 of the present embodiment detects at least one of the inclination about the X-axis, the inclination about the Y-axis, and the inclination about the Z-axis, and transmits a remote signal including a command corresponding to the detected inclination to the marine vessel 1 (the onboard device 140). Specifically, when the inclination of the mobile terminal 2 about the X-axis is detected, the mobile terminal 2 transmits, to the onboard device 140, a remote signal including a command for designating one of the front-rear directions as the propulsion direction and a command for designating the magnitude of the propulsion force. In addition, when the inclination of the mobile terminal 2 about the Y-axis is detected, the mobile terminal 2 transmits a remote signal including a command for designating one of the left and right directions as the propulsion direction and a command for designating the magnitude of the propulsion force to the onboard device 140. Further, when the inclination of the mobile terminal 2 about the Z-axis is detected, the mobile terminal 2 transmits, to the onboard device 140, a remote signal including a command for designating one of the left and right turning directions as the propulsion direction and a command for designating the magnitude of the propulsion force. Details of detection of inclination and transmission of a remote signal will be described later.

According to the remote maneuvering system of the present embodiment, the user can remotely operate the translation and the turning of the marine vessel 1 by rotating the mobile terminal 2 around X-Z shaft.

### Configuration of Remote Maneuvering System

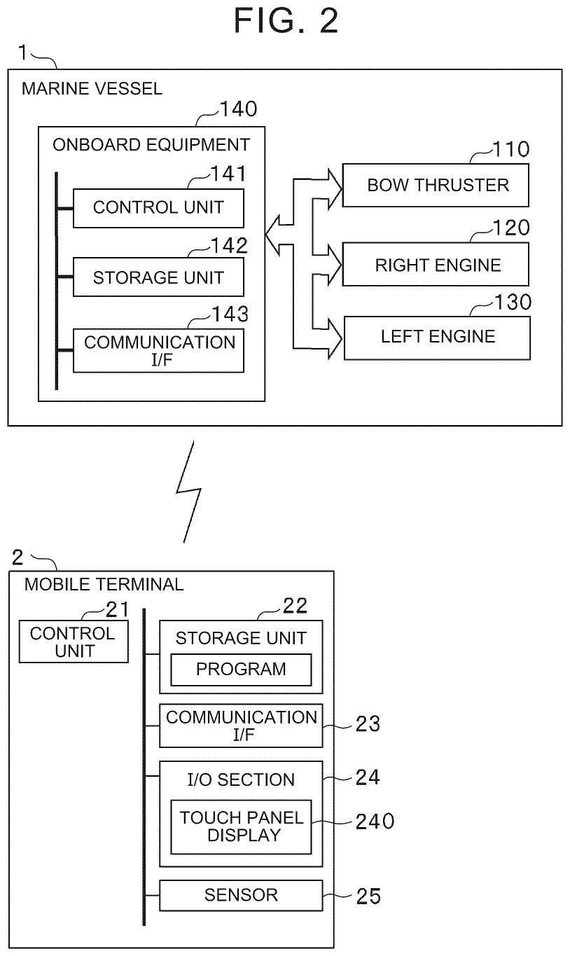

Here, the configuration of the marine vessel 1 and the mobile terminal 2 included in the remote maneuvering system will be described with reference to FIG. 2. FIG. 2 is a diagram schematically illustrating an example of the configuration of each of the marine vessel 1 and the mobile terminal 2.

As described above, the marine vessel 1 according to the present embodiment includes the bow thruster 110, the right engine 120, the left engine 130, and the onboard device 140. The onboard device 140 is connected to the bow thruster 110, the right engine 120, and the left engine 130 through an onboard network based on standards such as Controller Area Network (CAN), Local Interconnect Network (LIN), or FlexRay.

The onboard device 140 in the present embodiment is configured as a computer including a processor (such as a CPU or a GPU), a main storage device (such as a RAM and a ROM), and an auxiliary storage device (such as an EPROM, a hard disk drive, and a removable medium). As illustrated in FIG. 2, the onboard device 140 includes a control unit 141, a storage unit 142, a communication I/F 143, and the like.

The control unit 141 realizes various functions as described later by executing a dedicated program stored in the storage unit 142. For example, the control unit 141 includes a hardware processor such as Central Processing Unit (CPU) or Digital Signal Processor (DSP). The control unit 141 may further include a RAM, ROM, a cache memory, and the like.

The storage unit 142 includes an auxiliary storage device and stores various types of information. Note that the storage unit 142 may be a storage area constructed in the auxiliary storage device. In addition to OS, the data stored in the storage unit 142 includes a program for remote control, data used by the program, and the like.

The communication I/F 143 includes a communication interface for connecting the onboard device 140 to an onboard network, and a wireless communication interface for connecting the onboard device 140 to an outboard network (for example, a Wide Area Network (WAN) that is a global public communication network such as the Internet, a wireless communication network such as Wi-Fi (registered trademark), and the like). In one instance, the communication I/F 143 may include a communication interface for mobile communication (e.g., 3G, LTE, 5G, 6G, etc.) and a wireless communication interface for near field communication. The communication I/F 143 of the present embodiment communicates with the bow thruster 110, the right engine 120, and the left engine 130 through an inboard network. Further, the communication I/F 143 of the present embodiment connects to the outboard network by using radio communication, and communicates with the mobile terminal 2 through the outboard network.

In the marine vessel 1 configured as described above, the onboard device 140 controls the bow thruster 110, the right engine 120, and the left engine 130 in response to a remote signal transmitted from the mobile terminal 2. Here, in a case where a command for designating a forward direction (or a rearward direction) as a propulsion direction and a command for designating a magnitude of a forward direction (or a rearward direction) propulsion force are included in the remote signal, the control unit 141 of the onboard device 140 controls the engine (control for generating a propulsion force for causing the bow thruster 110 to stop and causing the right engine 120 and the left engine 130 to propel the stern portion forward (or rearward)) so as to generate a propulsion force for translating the hull 10 forward (or rearward). In addition, in a case where a command for designating the left direction (or the right direction) as the propulsion direction and a command for designating the magnitude of the propulsive force in the left direction (or the right direction) are included in the remote signal, the control unit 141 of the onboard device 140 controls the engine (control for generating a propulsive force for the bow thruster 110 to propel the bow portion leftward (or the right direction) and for generating a propulsive force for the right engine 120 and the left engine 130 to propel the stern portion rightward (or the left direction)) so as to generate a propulsive force for translating the hull 10 leftward (or the right direction). In addition, in a case where a command for designating a left turning direction (or a right turning direction) as a propulsion direction and a command for designating a magnitude of a propulsive force in a left turning direction (or a right turning direction) are included in the remote signal, the control unit 141 of the onboard device 140 controls the engine (control for generating a propulsive force for causing the bow thruster 110 to propel the bow portion in the left direction (or the right direction) and for causing the right engine 120 and the left engine to propel the stern portion in the right direction (or the left direction)) so as to generate a propulsive force for turning the hull 10 in the left direction (or the right direction).

Next, the configuration of the mobile terminal 2 will be described. The mobile terminal 2 is configured as a portable computer including a processor (such as a CPU or a GPU), a main storage device (such as a RAM and a ROM), and an auxiliary storage device (such as an EPROM, a hard disk drive, and a removable medium). As illustrated in FIG. 2, the mobile terminal 2 includes a control unit 21, a storage unit 22, a communication I/F 23, an input/output unit 24, and a sensor 25.

The control unit 21 realizes various functions as described later by executing a dedicated program stored in the storage unit 22. For example, the control unit 21 includes a hardware processor such as Central Processing Unit (CPU) or Digital Signal Processor (DSP). The control unit 21 may further include a RAM, ROM, a cache memory, and the like.

The storage unit 22 includes an auxiliary storage device and stores various types of information. Note that the storage unit 22 may be a storage area constructed in the auxiliary storage device. The information stored in the storage unit 22 includes, in addition to OS, an application program for remote control, data used by the program, and the like. An application program for remote control stored in the storage unit 22 of the mobile terminal 2 corresponds to a “program” according to the present disclosure.

The communication I/F 23 includes a radio communication interface for connecting the mobile terminal 2 to a network. In one instance, the communication I/F 23 may include a communication interface for mobile communication and a wireless communication interface for near field communication. The communication I/F 23 of the present embodiment is connected to a network using radio communication, and communicates with the onboard device 140 of the marine vessel 1 through the network.

The input/output unit 24 receives an input operation of a user who remotely operates the marine vessel 1, and presents information to the user. The input/output unit 24 in the present embodiment includes an input/output touch panel display 240.

The sensor 25 detects each of the inclination of the mobile terminal 2 about the X-axis, the inclination of the mobile terminal 2 about the Y-axis, and the inclination of the mobile terminal 2 about the Z-axis. In one example, the sensor 25 may include a three-axis acceleration sensor. In another example, the sensor 25 may include a three-axis gyro sensor.

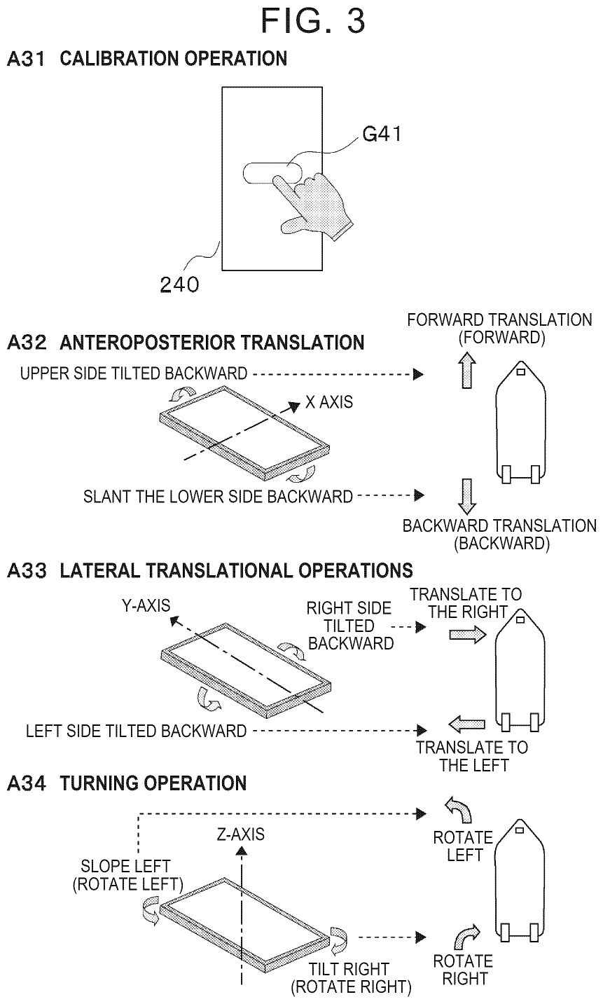

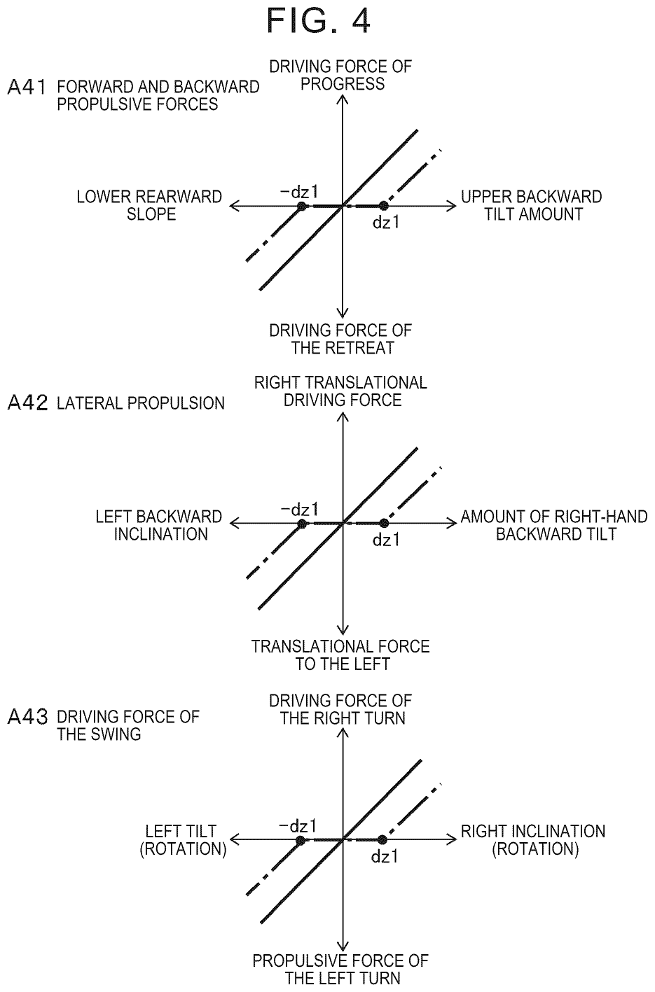

In the mobile terminal 2 configured as described above, the following functions are realized by the control unit 21 executing the application program of the storage unit 22. Hereinafter, functions realized by the mobile terminal 2 will be described with reference to FIGS. 3 and 4. FIG. 3 is a diagram for explaining an example of a procedure of remotely operating the marine vessel 1 using the mobile terminal 2. FIG. 4 is a diagram illustrating an example of a method of determining a magnitude of a propulsive force in remote control.

In the mobile terminal 2, when the user performs an operation of activating an application program through the input/output unit 24, the control unit 21 outputs a user interface screen for a calibration operation to the input/output unit 24 through execution of the application program. The user interface screen for the calibration operation is an operation screen for calibrating the sensor 25. The calibration of the sensor 25 in the present embodiment means that the sensor 25 learns the neutral attitude of the mobile terminal 2 (the attitude in which the tilt amount around X-Z shaft is set to zero). The user interface screen for the calibration operation may include a GUI component (G41 in FIG. 3) indicating a button for executing the calibration, as shown in A31 in FIG. 3. In the user interface window shown in A31 in FIG. 3, when the user performs an operation (for example, a tapping operation) of pressing the calibration execution button G41, the control unit 21 performs calibration of the sensor 25. Specifically, the control unit 21 sets the output value of the sensor 25 (the amount of inclination about the X-axis, the amount of inclination about the Y-axis, and the amount of inclination about the Z-axis) to zero at the time point when the execution button G41 is operated. Thus, the posture of the mobile terminal 2 at the time when the output value of the sensor 25 is set to zero is learned by the sensor 25 as a neutral posture. Note that the calibration of the sensor 25 may be performed using an operation of an existing physical button on the mobile terminal 2 as a trigger. In this case, a message prompting the user to operate the physical button may be displayed on the calibration user interface screen.

After the calibration of the sensor 25 is performed, when the user performs a remote operation (an operation of tilting the mobile terminal 2 around X-Z shaft), the control unit 21 detects the amount of tilt around X-Z shaft through the sensor 25, and sets the propulsion direction and the magnitude of the propulsive force of the marine vessel 1 in accordance with the detected amount of tilt.

Here, when the user performs a remote operation of tilting the mobile terminal 2 about the X-axis from the neutral posture, the control unit 21 detects the amount of tilt from the neutral posture about the X-axis through the sensor 25. The control unit 21 sets the propulsion direction and the magnitude of the propulsive force in accordance with the detected amount of inclination about the X-axis. Here, as shown in A41 in FIG. 4, the sensor 25 in the present embodiment outputs the amount of inclination when the upper side of the mobile terminal 2 is inclined backward around the X-axis as a positive value, and outputs the amount of inclination when the lower side of the mobile terminal 2 is inclined backward around the X-axis as a negative value. Therefore, in the present embodiment, if the amount of inclination about the X-axis detected by the sensor 25 is a positive value, the propulsion direction is set to the forward direction (forward translation) of the marine vessel 1, and the propulsion force is set to a larger value as the absolute value of the amount of inclination is larger. On the other hand, if the amount of inclination about the X-axis detected by the sensor 25 is a negative value, the propulsion direction is set to the rearward direction of the marine vessel 1 (translated in the rearward direction), and the propulsive force is set to a larger value as the absolute value of the amount of inclination is larger. When the propulsion direction and the magnitude of the propulsion force are set in this manner, the control unit 21 transmits a remote signal for translating the marine vessel 1 in the forward direction or the backward direction to the onboard device 140, as shown in A32 in FIG. 3. The remote signal includes a command for designating a forward direction or a backward direction as a propulsion direction, and a command for designating a magnitude of a propulsion force.

When the user performs a remote operation of tilting the mobile terminal 2 from the neutral posture to the Y-axis, the control unit 21 detects the amount of tilt from the neutral posture about the Y-axis through the sensor 25. The control unit 21 sets the propulsion direction and the magnitude of the propulsive force in accordance with the detected amount of inclination about the Y-axis. Here, as shown in A42 in FIG. 4, the sensor 25 in the present embodiment outputs an inclination amount when the right side of the mobile terminal 2 is inclined backward around the Y-axis as a positive value, and outputs an inclination amount when the left side of the mobile terminal 2 is inclined backward around the Y-axis as a negative value. Therefore, in the present embodiment, if the amount of inclination about the Y-axis detected by the sensor 25 is a positive value, the propulsion direction is set to the right direction (translation in the right direction) of the marine vessel 1, and the propulsion force is set to a larger value as the absolute value of the amount of inclination is larger. On the other hand, if the inclination amount around the Y-axis detected by the sensor 25 is a negative value, the propulsion direction is set to the leftward direction of the marine vessel 1 (translated leftward), and the propulsion force is set to a larger value as the absolute value of the inclination amount is larger. When the propulsion direction and the magnitude of the propulsion force are set in this manner, the control unit 21 transmits a remote signal for translating the marine vessel 1 in the rightward direction or the leftward direction to the onboard device 140, as shown in A33 in FIG. 3. In this case, the remote signal includes a command for designating the right direction or the left direction as the propulsion direction and a command for designating the magnitude of the propulsion force.

Further, when the user performs a remote operation of tilting the mobile terminal 2 about the Z-axis from the neutral posture, the control unit 21 detects the amount of tilt from the neutral posture about the Z-axis through the sensor 25. The control unit 21 sets the propulsion direction and the magnitude of the propulsive force in accordance with the detected amount of inclination about the Z-axis. Here, as shown in A43 in FIG. 4, the sensor 25 in the present embodiment outputs the amount of inclination when the mobile terminal 2 is inclined in the right direction around the Z-axis as a positive value, and outputs the amount of inclination when the mobile terminal 2 is inclined in the left direction around the Z-axis as a negative value. Therefore, in the present embodiment, if the amount of inclination about the Z-axis detected by the sensor 25 is a positive value, the propulsion direction is set to the rightward turning direction (turning in the rightward direction) of the marine vessel 1, and the propulsion force is set to a larger value as the absolute value of the amount of inclination is larger. On the other hand, if the amount of inclination about the Z-axis detected by the sensor 25 is a negative value, the propulsion direction is set to the leftward turning direction (turning leftward) of the marine vessel 1, and the propulsive force is set to a larger value as the absolute value of the amount of inclination is larger. When the propulsion direction and the magnitude of the propulsion force are set in this manner, the control unit 21 transmits a remote signal for turning the marine vessel 1 in the rightward direction or the leftward direction to the onboard device 140, as shown in A34 in FIG. 3. In this case, the remote signal includes a command for designating the right turning direction or the left turning direction as the propulsion direction, and a command for designating the magnitude of the propulsion force.

In the setting of the magnitude of the propulsive force, the propulsive force may be set to a value larger than zero on condition that the absolute value of the amount of inclination around X-Z shaft is larger than zero, as indicated by the solid line of the thick line in FIG. 4, but the propulsive force may be set to a value larger than zero on condition that the absolute value of the amount of inclination around X-Z shaft is larger than the predetermined value dz1, as indicated by the dashed-dotted line of the thick line in FIG. 4. In other words, a dead zone corresponding to a predetermined dz1 may be set with respect to the inclination around X-Z shaft. Accordingly, when it is difficult for the user to keep the mobile terminal 2 in the neutral posture, it is possible to suppress the occurrence of a propulsive force on the marine vessel 1 that is contrary to the intention of the user.

In addition, when the marine vessel 1 is translated in an oblique direction (for example, a right front direction, a right rear direction, a left front direction, and a left rear direction), the user may simultaneously perform an operation of tilting the mobile terminal 2 about the X-axis and an operation of tilting the mobile terminal 2 about the Y-axis. In this case, the control unit 21 of the mobile terminal 2 may detect the amount of inclination about the X-axis and the amount of inclination about the Y-axis through the sensor 25, and set the propulsion direction and the magnitude of the propulsive force of the marine vessel 1 in accordance with the detected amount of inclination about the X-axis and the amount of inclination about the Y-axis.

Further, in a case where another remote control is performed after one remote control is performed, the control unit 21 of the mobile terminal 2 may receive another remote control on condition that the posture of the mobile terminal 2 is returned to the neutral posture after one remote control is performed. Alternatively, after one remote operation is performed, the control unit 21 of the mobile terminal 2 may output the user interface screen for the calibration operation as described above to the input/output unit 24, calibrate the sensor 25, and then receive another remote operation.

Process flow

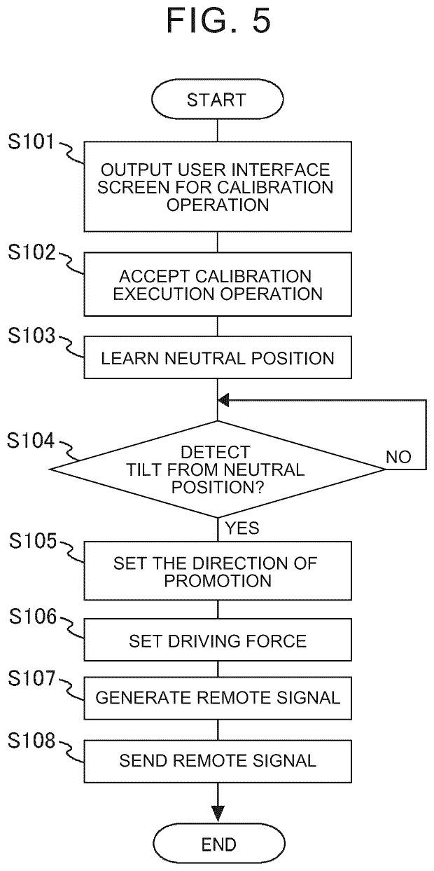

Here, a flow of processing executed by the mobile terminal 2 according to the present embodiment will be described with reference to FIG. 5. FIG. 5 is a flowchart illustrating an example of a processing routine executed by the mobile terminal 2 in response to activation of an application program for remote control.

In the process routine of FIG. 5, the control unit 21 of the mobile terminal 2 first outputs the user interface screen (see A31 in FIG. 3) for the calibration operation described in the above explanation of FIG. 3 to the input/output unit 24 (S101). Upon completion of S101 process, the control unit 21 executes S102 process.

In S102, the control unit 21 receives an operation of executing the calibration while the user interface screen for the calibration operation is outputted. In one embodiment, the control unit 21 receives an operation (for example, a tapping operation) of pressing an execution button G41 as illustrated in A31 in FIG. 3. Upon completion of S102 process, the control unit 21 executes S103 process.

In S103, the control unit 21 causes the sensor 25 to learn the neutral attitude of the mobile terminal 2 by executing the calibration of the sensor 25. Specifically, the control unit 21 sets the output value of the sensor 25 (the amount of inclination about the X-axis, the amount of inclination about the Y-axis, and the amount of inclination about the Z-axis) to zero at the time when the operation of pressing the execution button G41 described above is received. Upon completion of S103 process, the control unit 21 executes S104 process.

In S104, the control unit 21 determines whether the mobile terminal 2 is tilted from the neutral position through the sensor 25. Here, if the output value of the sensor 25 (the amount of inclination about the X-axis, the amount of inclination about the Y-axis, and the amount of inclination about the Z-axis) is zero (or the absolute value of the output value is equal to or less than the predetermined value dz1), the control unit 21 determines that the mobile terminal 2 is not inclined from the neutral posture (negative determination in S104). In this case, the control unit 21 waits until the mobile terminal 2 is tilted from the neutral posture. Further, when the output value of the sensor 25 (the amount of inclination about the X-axis, the amount of inclination about the Y-axis, and the amount of inclination about the Z-axis) is not zero (or when the absolute value of the output value is larger than the predetermined value dz1), the control unit 21 determines that the mobile terminal 2 is inclined from the neutral position (affirmative determination in S104). In this situation, the control unit 21 executes S105 process.

In S105, the propulsion direction of the marine vessel 1 is set in accordance with the output value of the sensor 25. Here, when the sensor 25 detects the inclination around the X-axis (the amount of inclination around the X-axis/zero (or the absolute value of the amount of inclination around the X-axis>the predetermined value dz1), the amount of inclination around the Y-axis=zero (or the absolute value of the amount of inclination around the Y-axis<the predetermined value dz1), the amount of inclination around the Z-axis=zero (or the absolute value of the amount of inclination around the Z-axis≤the predetermined value dz1)), the control unit 21 sets the propulsion direction to the forward direction (forward translation) if the amount of inclination around the X-axis is a positive value. On the other hand, if the amount of inclination around the X-axis is a negative value, the control unit 21 sets the propulsion direction to the rear direction (translated in the rear direction).

Further, when the sensor 25 detects the inclination around the Y-axis (the amount of inclination around the X-axis=zero (or the absolute value of the amount of inclination around the X-axis≤the predetermined value dz1), the amount of inclination around the Y-axis≠zero (or the absolute value of the amount of inclination around the Y-axis>the predetermined value dz1), the amount of inclination around the Z-axis=zero (or the absolute value of the amount of inclination around the Z-axis≤the predetermined value dz1)), the control unit 21 sets the propulsion direction to the rightward direction (translated rightward) if the amount of inclination around the Y-axis is a positive value. On the other hand, if the amount of inclination about the Y-axis is a negative value, the control unit 21 sets the propulsion direction to the left direction (translation to the left direction).

Further, when the sensor 25 detects the inclination around the Z-axis (the amount of inclination around the X-axis=zero (or the absolute value of the amount of inclination around the X-axis≤the predetermined value dz1), the amount of inclination around the Y-axis=zero (or the absolute value of the amount of inclination around the Y-axis≤the predetermined value dz1), the amount of inclination around the Z-axis≠zero (or the absolute value of the amount of inclination around the Z-axis>the predetermined value dz1)), the control unit 21 sets the propulsion direction to the right-handed direction (the right-handed direction) if the amount of inclination around the Z-axis is a positive value. On the other hand, if the amount of inclination about the Z-axis is a negative value, the control unit 21 sets the propulsion direction to the left-turning direction (turning to the left direction).

Upon completion of S105 process, the control unit 21 executes S106 process. In S106, the control unit 21 sets the magnitude of the propulsive force of the marine vessel 1 in accordance with the output of the sensor 25. In an example, as described with reference to FIG. 4, the control unit 21 sets the propulsive force to be larger as the absolute value of the output value of the sensor 25 is larger. At this time, the magnitude of the propulsive force may be set to be proportional to the absolute value of the output value of the sensor 25, or may be set to be a value that is gradually larger as the absolute value of the output value of the sensor 25 increases, or may be set to be a value that is exponentially larger as the absolute value of the output value of the sensor 25 increases. Upon completion of S106 process, the control unit 21 executes S107 process.

In S107, the control unit 21 generates a remote signal according to the propulsion direction and the magnitude of the propulsion force set by S105 and S106. The remote signal is a signal including a command for specifying the propulsion direction set by S105 and a command for specifying the magnitude of the propulsive force set by S106. Upon completion of S107 process, the control unit 21 executes S108 process.

In S108, the control unit 21 transmits the remote signal generated by S107 to the onboard device 140 of the marine vessel 1 that is a target of remote control through the communication I/F 23. When S108 processing is finished, the control unit 21 ends the execution of this processing routine. Note that the control unit 21 may repeatedly execute S101 and subsequent processes after executing S108 process.

According to the remote maneuvering system described above, the user can propel the marine vessel 1 in an arbitrary propulsion direction by tilting the mobile terminal 2 around an arbitrary axis around the X axis, the Y axis, and the Z axis. Accordingly, the user can intuitively remotely operate the marine vessel 1. As a result, operability when the marine vessel 1 is remotely operated can be improved.

### Modification

In the above-described embodiment, an example has been described in which remote control of the forward and backward translations, the left and right translations, and the left and right pivots of the marine vessel 1 is achieved by the operation of tilting the mobile terminal 2. On the other hand, in the present modification, an example will be described in which only the remote operation for turning the marine vessel 1 in the left-right direction is achieved by the operation of tilting the mobile terminal 2, and the translation of the marine vessel 1 in the front-rear direction and the translation in the left-right direction are achieved by the touch operation on the touch panel display 240. In the present modification, an example in which a remote operation is performed for turning the marine vessel 1 in the left-right direction in accordance with an inclination operation of the mobile terminal 2 about the Y-axis will be described.

In the present modification example, when the user performs an operation of activating the application program through the input/output unit 24, the control unit 21 outputs a user interface screen for the calibration operation to the input/output unit 24 through execution of the application program. The user interface screen for the calibration operation may be the same as the above-described embodiment (see A31 in FIG. 3). When the user performs an operation of pressing the calibration execution button G41 on the user interface screen for the calibration operation, the control unit 21 executes the calibration of the sensor 25. In the present modification, the calibration of the sensor 25 only needs to be performed with respect to the amount of inclination about the Y-axis. In a case where the remote operation for turning the marine vessel 1 in the left-right direction is performed in accordance with the inclination operation of the mobile terminal 2 around the X-axis, the calibration of the sensor 25 may be performed only for the inclination amount around the X-axis. In addition, in a case where the remote operation for turning the marine vessel 1 in the left-right direction is performed in accordance with the tilting operation of the mobile terminal 2 around the Z-axis, the calibration of the sensor 25 may be performed only for the amount of tilting around the Z-axis.

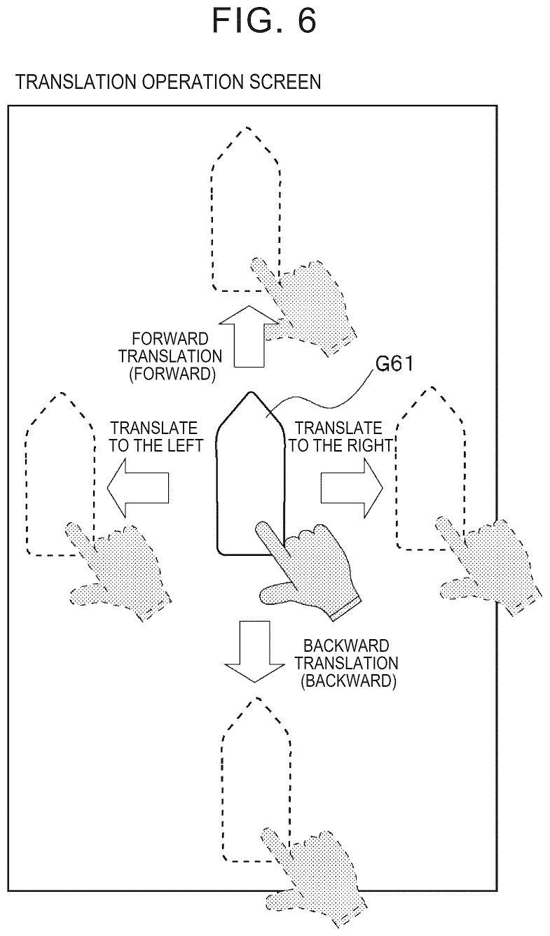

When the calibration of the sensor 25 is executed by the above-described method, the control unit 21 of the mobile terminal 2 outputs a user interface screen for a translational operation (hereinafter, sometimes referred to as a “translational operation screen”) to the input/output unit 24. FIG. 6 is a diagram illustrating an example of a translation operation screen. As shown in FIG. 6, an icon (G61 in FIG. 6) corresponding to the marine vessel 1 is displayed on the translational manipulation screen. In such a translational operation screen, when an operation of sliding the icon G61 of the marine vessel 1 in the front-rear direction or the left-right direction (that is, a sliding touch operation of sliding the icon G61 in the front-rear direction or the left-right direction while touching the icon) is performed, the control unit 21 sets the propulsion direction and the magnitude of the propulsive force of the marine vessel 1 in accordance with the sliding direction and the sliding amount of the sliding touch operation.

Here, when the slide touch operation is an operation of sliding the icon G61 upward, the control unit 21 sets the propulsion direction to the forward direction (forward translation) of the marine vessel 1, and sets the propulsive force to a larger value as the slide amount of the slide touch operation increases. When the slide touch operation is an operation of sliding the icon G61 in the downward direction, the control unit 21 sets the propulsion direction in the rearward direction (backward translation) of the marine vessel 1, and sets the propulsive force to a larger value as the slide amount of the slide touch operation increases. When the slide touch operation is an operation of sliding the icon G61 in the rightward direction, the control unit 21 sets the propulsion direction to the rightward direction of the marine vessel 1 (translation in the rightward direction), and sets the propulsive force to a larger value as the slide amount of the slide touch operation increases. When the slide touch operation is an operation of sliding the icon G61 in the leftward direction, the control unit 21 sets the propulsion direction to the leftward direction of the marine vessel 1 (translation in the leftward direction), and sets the propulsive force to a larger value as the slide amount of the slide touch operation increases.

When the slide touch operation is an operation of sliding the icon G61 in an oblique direction (upward-right direction, downward-right direction, upward-left direction, or downward-left direction), the control unit 21 may set the propulsion direction in the oblique direction of the marine vessel 1 (translation in the oblique direction), and set the propulsive force to a larger value as the slide amount of the slide touch operation increases.

When the mobile terminal 2 is tilted around the Y-axis from the neutral posture in a state where the translational operation screen is output, the control unit 21 detects the amount of tilt from the neutral posture around the Y-axis through the sensor 25. Then, the control unit 21 sets the magnitude of the propulsive force in the turning direction and the turning of the marine vessel 1 in accordance with the detected amount of inclination about the Y-axis. The sensor 25 in the present modification outputs, as a positive value, the amount of inclination when the right side of the mobile terminal 2 is inclined backward around the Y-axis, and outputs, as a negative value, the amount of inclination when the left side of the mobile terminal 2 is inclined backward around the Y-axis, as in the same manner as in the above-described embodiment. Therefore, in the present modification example, if the amount of inclination about the Y-axis detected by the sensor 25 is a positive value, the propulsion direction is set to the right turning direction (turning to the right direction) of the marine vessel 1, and the propulsion force is set to a larger value as the absolute value of the amount of inclination is larger. On the other hand, if the amount of inclination about the Y-axis detected by the sensor 25 is a negative value, the propulsion direction is set to the leftward turning direction (turning leftward) of the marine vessel 1, and the propulsive force is set to a larger value as the absolute value of the amount of inclination is larger.

According to the present modification, it is possible to further improve the operability when the translational motion of the marine vessel 1 is remotely operated.

### Other

The above-described embodiments and modifications are merely examples, and the present disclosure may be appropriately modified without departing from the gist thereof. For example, in the embodiment, the remote signal may include an inclination direction (information identifying whether the inclination is about the X-axis, the inclination is about the Y-axis, or the inclination is about the Z-axis) and an inclination amount of the mobile terminal 2. In this case, the control unit 21 of the onboard device 140 may set the propulsion direction and the magnitude of the propulsive force in accordance with the inclination direction and the inclination amount included in the remote signal. Further, in the modified example, the remote operation for the turning of the marine vessel 1 in the left-right direction may be achieved by the touch operation on the touch panel display 240, and the remote operation for the translation of the marine vessel 1 in the front-rear direction and the translation in the left-right direction may be achieved by the operation of tilting the mobile terminal 2.

The present disclosure can also be realized by supplying a computer program (information processing program) that implements the functions described in the above embodiments to a computer, and one or more processors included in the computer read and execute the program. Such a computer program may be provided to a computer by a non-transitory computer readable storage medium connectable to a system bus of the computer, or may be provided to the computer via a network. A non-transitory computer-readable storage medium is a storage medium that stores information such as data and programs by electrical, magnetic, optical, mechanical, or chemical action, and can be read from a computer or the like. Examples of such a recording medium include any types of disks such as magnetic disks (floppy disks, HDD, or the like) and optical disks (CD-ROM, DVD disks, Blu-ray disks, or the like). The recording medium may be a medium such as a ROM, RAM, EPROM, EEPROM, a magnetic card, a flash memory, an optical card, or a Solid State Drive (SSD).

What is claimed is:

1. An information processing method for remotely operating a marine vessel using a mobile terminal, the information processing method comprising causing the mobile terminal to perform:
detecting a tilt of the mobile terminal from a neutral posture; and
transmitting, to the marine vessel, a command for generating a propulsive force corresponding to at least a first propulsion direction out of a plurality of propulsion directions in response to the detecting of the tilt of the mobile terminal from the neutral posture.

2. The information processing method according to claim 1, wherein:
the mobile terminal is a terminal including a touch panel display; and
the mobile terminal is configured to further perform:
detecting a touch operation on the touch panel display; and
transmitting, to the marine vessel, a command for generating a propulsive force corresponding to a second propulsion direction different from the first propulsion direction out of the plurality of propulsion directions in response to the detecting of the touch operation on the touch panel display.

3. The information processing method according to claim 2, wherein:
the tilt of the mobile terminal from the neutral posture is a tilt about an axis in a right-left direction, a tilt about an axis in an up-down direction, or a tilt about an axis in a front-rear direction;
the first propulsion direction is a turning direction of the marine vessel;
the touch operation is a slide touch operation in the up-down direction on the touch panel display or a slide touch operation in the right-left direction on the touch panel display; and
the second propulsion direction is the front-rear direction of the marine vessel and/or the right-left direction of the marine vessel.

4. The information processing method according to claim 1, wherein the mobile terminal is configured to further perform:
acquiring an amount of the tilt of the mobile terminal from the neutral posture;
determining a magnitude of the propulsive force in the first propulsion direction according to the acquired amount of the tilt; and
transmitting a command for specifying the determined magnitude of the propulsive force to the marine vessel.

5. A program for causing a computer to perform the information processing method according to claim 1.
